(19) United States
(12) Patent Application Publication
(10) Pub. No.: US 2013/0151424 A1
(43) Pub. Date: Jun. 13, 2013

(54) SYSTEMS, METHODS AND COMPUTER PROGRAM PRODUCTS FOR GENERATING AND SHARING INFORMATION AMONG A PLURALITY OF PERSONS

(71) Applicants: Cheryl Anne Milone, New York, NY (US); John Cronin, Jericho, VT (US); Raymond Felts, New York, NY (US)

(72) Inventors: Cheryl Anne Milone, New York, NY (US); John Cronin, Jericho, VT (US); Raymond Felts, New York, NY (US)

(21) Appl. No.: 13/666,761

(22) Filed: Nov. 1, 2012

Related U.S. Application Data
(60) Provisional application No. 61/548,823, filed on Nov. 7, 2011.

(51) Int. Cl. G06Q 50/18; G06Q 10/00

(52) U.S. Cl. CPC G06Q 50/184; G06Q 10/00
USPC 705/310

(57) ABSTRACT

Embodiments of methods and systems for generating and sharing information among a plurality of registered subscribers are generally described herein. Embodiments of methods and systems for ranking members of a group are generally described herein. Embodiments of methods for reviewing a plurality of patent documents are generally described herein.

### PRIORITY CLAIM

This application claims the benefit of priority under 35 U.S.C. §119(e) to U.S. Provisional Patent Application Ser. No. 61/548,823, filed Nov. 7, 2011, which is incorporated herein in its entirety.

### TECHNICAL FIELD

Some embodiments pertain to the field of information gathering and sharing.

### BACKGROUND

When a person wants to know an answer to a question, he or she rarely has infinite resources to search for that answer. Typically, the search is limited by one or more of the following: time available to spend looking for the answer, the number of persons who look for the answer, the amount of money spent to conduct the searches, the number of resources in, for example, hardcopy or electronic form, or databases that are consulted, and the quality of those technology, hard copy or human resources. Among the most valuable types of information is information that relates to a patent including but not limited to its validity and the state of the art in the relevant technology field.

A patent is an intellectual property right that can permit a patent holder to demand licenses from infringers and to obtain injunctions to preclude competitors from making, using, offering for sale or selling goods or services that embody the claimed invention. Indisputably, patents have the potential to be valuable assets to inventors, patent owners and investors. They also have the potential to shut down or to increase the costs of operation for other entities. Unfortunately, not all patents are created equal and some should never have issued.

During the process of applying for a patent, a patent applicant submits an application to a Patent Office for the purpose of determining whether the claimed invention is patentable. In most Patent Offices around the world, two of the criteria that are considered when determining whether an invention is patentable are: (1) is the claimed invention novel; and (2) is the claimed invention non-obvious (in e.g., the U.S.) or does it possess an inventive step (in e.g., Europe)? In order to determine whether these criteria have been met, Patent Examiners conduct prior art searches. The phrase “prior art” is well known to inventors, as well as to attorneys and agents who prosecute patent applications and attorneys and businesspersons who license patents and patent applications, and includes but is not limited to printed publications such as journal articles, patents, patent applications, public uses and evidence of public sales that may, alone or in combination with other prior art and according to the patent laws of one or more jurisdictions be the basis for invalidating one or more claims of one or more patents. However, in some circumstances, due to the limited resources provided to Examiners, the searches may be limited by both the amount of time that an Examiner has to conduct the searches and the number of hard copy or database resources or other sources of prior art that he or she can access.

For a percentage of patents searched, Examiners uncover the most relevant art and the patent is correctly issued. For other patents that are issued, the Examiner does not uncover all of the relevant art. The most relevant art may only be brought to light when a patent is challenged in either an enforcement action or a specially designed adjudicatory forum such as a U.S. Reexamination Proceeding in the United States Patent Office or an Opposition Proceeding in the European Patent Office that permits members of the public to challenge a patent's validity.

By the time that one of these dispute resolution processes is invoked, the need to identify the most relevant art becomes critical to determining the impact on a potential alleged infringer. Due to the potential damages that may be awarded from patent infringement, an interested party may spend tens of thousands, if not hundreds of thousands of dollars searching for and investigating prior art issues, i.e., looking for prior art that can invalidate the patent. For a large company that may find itself subject to accusations of infringement of a number of patents, the costs of investigating prior art issues may quickly become unacceptably high.

Additionally, prior art can be of value even if not used to invalidate a claim of a patent. For example, it may provide information as to the state of the art at a particular time, and may provide suggestions for other avenues of research and development. However, as with searches to invalidate a patent, when conducting a prior art search for purposes of a review of the state of the art, the value of the conclusions that can be drawn may be limited by the resources expended and the quality of art obtained.

Example embodiments, described herein, seek to provide solutions to one or more of the shortcomings of present methods, technologies and systems for finding and accessing information that may, for example, be used in prior art analyses. Example embodiments further provide methods by which to motivate persons to submit this information and to maximize the likelihood that submissions from the most likely valuable contributors are considered.

### SUMMARY

Example embodiments are directed to the use of methods, systems and computer program products that provide for efficient pooling of resources. Other embodiments provide systems, methods and computer program products for analyzing information. Other embodiments systems, methods and computer program products for ranking members of a group who contribute information.

According to a first embodiment, there is provided a method for generating and sharing information among a plurality of registered subscribers comprising: (a) offering a plurality of potential subscribers an opportunity to join a group, wherein the group is comprised of members who are interested in a common technology field and upon joining the group, the potential subscribers become registered subscribers; (b) publicizing a first request for prior art, wherein the first request asks for prior art that is related to at least one patent claim of a first patent or to a state of the art of the technology of said first patent; (c) receiving a request from at least one additional entity to join the group and permitting the additional entity to become a registered subscriber; (d) receiving prior art related to said claim of said first patent or to said state of the art of the technology of said first patent; (e) providing access to results of the request for prior art related to said claim of the first patent or said state of the art of the technology of said first patent to the registered subscribers; (f) publicizing a second request for prior art, wherein the second request asks for prior art that is related to at least one patent claim of a second patent or a state of the art of the technology of said second patent, wherein the second request is publicized after an automatic triggering event, wherein the triggering event is an event selected from the group consisting of the filing of a complaint in court, wherein the second patent is the subject of litigation, and the second patent is part of said common technology field; the notification that a non-practicing entity has a acquired said second patent; and notification that a member of the group has received contact from an owner of the second patent, wherein within said contact reference has been made to the second patent; (g) receiving prior art related to a claim of said second patent or to said state of the art of the technology of the second patent; and (h) providing access to the results of the request for prior art related to a claim of the second patent or the state of the art of the technology of the second patent to the registered subscribers.

Prior art related to the validity of a claim may, alone or in combination with other art, invalidate the claim. Prior art related to the state of the art may provide information about what was known in the relevant field at the relevant time, but not necessarily provide information that bears on the validity of the claim. Either or both of the first request and second request may be directed to invalidating one or more claims of the first and/or second patent. Similarly, either or both of the first request and second request may be directed to the state of the art of the technology of the first and/or second patent. The “technology of the patent” may be the technology disclosed in one or more claims or in one or more places within the specification. In a state of the art search, the provider, upon publicizing a request may specify, for which aspect of the technology the prior art is sought.

In another embodiment, there is provided a system for analyzing the validity or infringement of a set of patent documents. The system comprises: (a) a set of patent documents comprising a plurality of patent documents; (b) an output standard, wherein the output standard is stored in computer readable form; (c) a reviewer variable receiving module, wherein the reviewer variable receiving module is configured to receive a plurality of reviewer variable values from a plurality of reviewers; (d) a quality variable receiving module, wherein the quality variable receiving module is configured to receive from a committee member a quality variable value to associate with a reviewer variable value; (e) a reviewer association module that is operably coupled to the reviewer variable receiving module and to the quality variable receiving module, wherein with each reviewer variable value at least one quality variable value is associated and stored in computer readable form; (f) a quality analysis module that is operably coupled to the reviewer association module, wherein for each patent document for which a quality variable value has been received, an automated analysis is performed to determine whether the reviewer variable value satisfies a quality condition; (g) an elevation module wherein the elevation module extracts data from the reviewer association module and determines that a reviewer may submit a quality variable value as a committee member when a reviewer has reviewed a predetermined number of patent documents and has received a predetermined number of high quality variable values; and (h) an output module wherein the output module generates a report that identifies a subset of patent documents that satisfy the quality condition and the output standard, and the system receives at least one quality variable value for a first patent document and at least one reviewer variable value for a second patent document from a committee member who is also a reviewer. In some embodiments, there are provided methods that access and use one or more, if not all of each of the aforementioned modules.

Example embodiments provide a method for ranking members of a group. The method comprises: (a) creating a database that stores a plurality of user profiles, wherein each user profile corresponds to a member of a group; (b) for each user profile, obtaining data that identifies at least one of the quality of information sources and the number of information sources to which the member has access and associating the data with the user profile; and (c) generating a ranking of members wherein the ranking assigns a relative value to members based on at least one or both of the quality of information sources and the number of information sources to which the member has access.

Example embodiments permit two or more entities to come together in order to pool resources and to ensure a more thorough review of prior art. By pooling these resources, the two or more entities may gain access to more prior art and thereby gain a more accurate perspective on the validity of a patent with respect to prior art or the state of the art. In embodiments in which compensation is provided for the best art, as more members join a group, the pool of money from the subscriptions will increase, thereby allowing more search requests to be posted and/or higher rewards to be paid to submitters of the art. Example embodiments may therefore create an economy of scale that is not present in traditional models.

Additionally, in various embodiments, the methods, systems and computer program products may be implemented in connection with crowdsourcing business models. For example, they may be used in conjunction with a network based crowdsourcing application such as that implemented by Article One Partners (see Appendix A, which is an excerpt from Article One Partners' website). Under this type of crowdsourcing application, a reward may be paid for prior art that is received in response to an information request. The amount and distribution of the reward may be determined by rating the quality and timing of receipt of the prior art. Thus, various embodiments provide ways to improve upon crowdsourcing information retrieval models.

### BRIEF DESCRIPTION OF THE DRAWINGS

FIG. 1 illustrates a system in which example embodiments may be implemented.

FIG. 2 is a flowchart of a method for generating and sharing information among a plurality of registered subscribers in accordance with example embodiments.

FIG. 3 is a block diagram of a provider system in accordance with example embodiments.

FIG. 4 is a block diagram of a system for analyzing patent validity in accordance with example embodiments.

FIG. 5 is a flowchart for reviewing a plurality of patent documents in accordance with example embodiments.

FIG. 6 is a flowchart of a method of a method for ranking members of a group in accordance with example embodiments.

### DETAILED DESCRIPTION

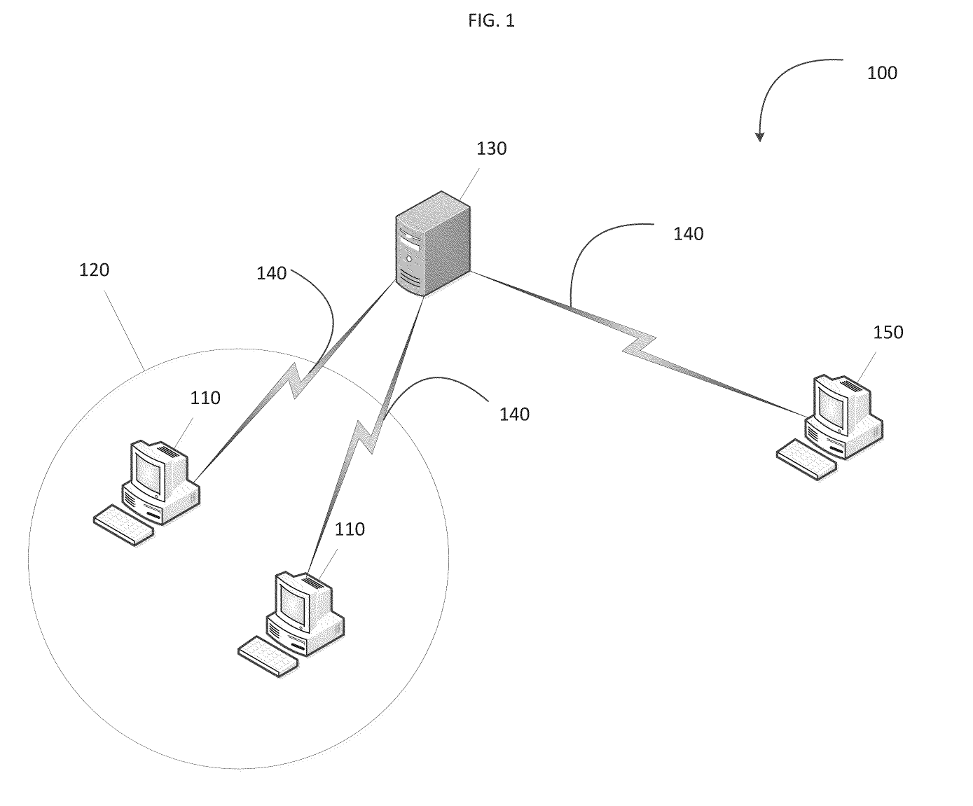

FIG. 1 illustrates a system 100 in which example embodiments are implemented. An example embodiment provides a method for generating and sharing information among a plurality of registered subscribers 110. A “subscriber” 110 may be a person or other legal entity such as a corporation or a partnership, who has requested and been granted access to information related to one or more issues or topics. A subscriber 110 may become registered by accepting an offer to become part of a group 120 that will be entitled to receive information, or otherwise by initiating an application with a provider 130 to become part of the group. Thus, one's status as a registered subscriber 110 is independent of how one completes the registration process or who initiates the application process. A “provider” 130 is an entity or person who administers or oversees administration of the methods or systems of example embodiments. A provider 130 may operate through one or more communication channels or over a network 140 such as the internet at, for example, a host website. Depending on the rules set forth by the provider 130, a subscriber 110 may be required to provide certain information such a corporate name or other user identification before completing the registration process for the group 120. In some embodiments, a user may be required to provide a payment of money in order to become a registered subscriber 110 and thus entitled to access to the desired information.

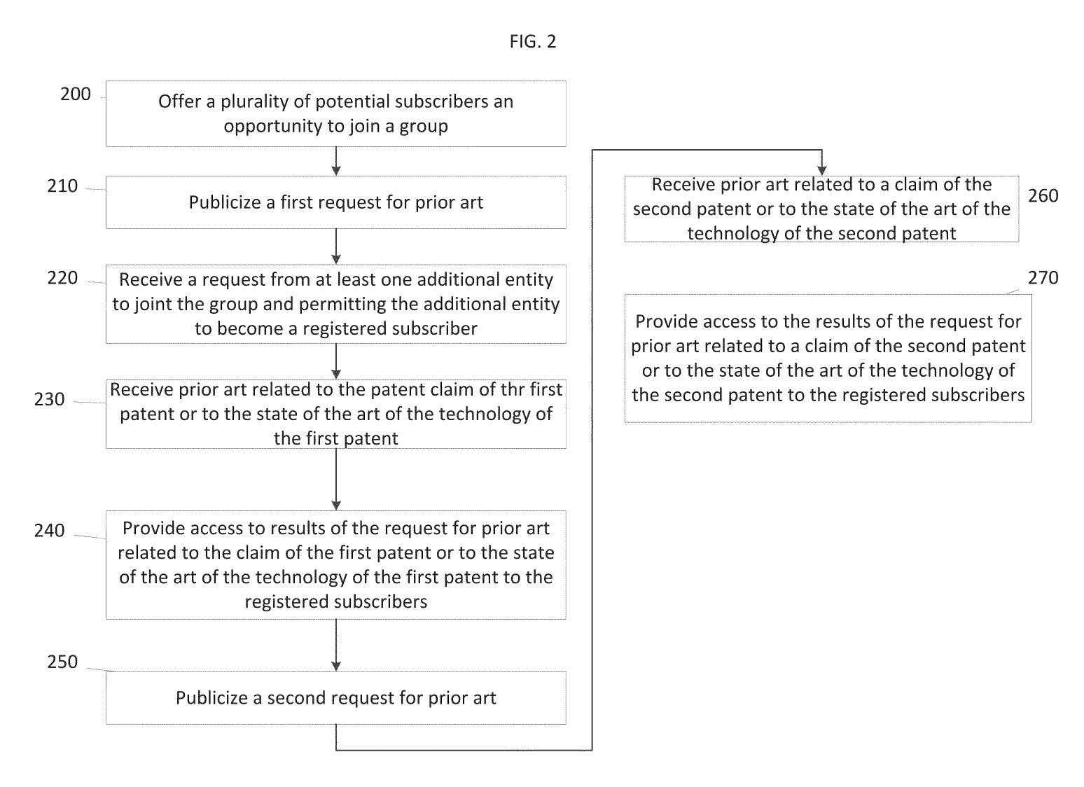

FIG. 2 illustrates a method for generating and sharing information among a plurality of registered subscribers. In operation 200, a provider 130 may offer a plurality of potential subscribers 150 an opportunity to join a group 120. The offer may be made through any channels that are now known or that come to be known for offering membership to a group 120. By way of non-limiting examples, the offer may be through one or more of the following: posting on a website; posting on a networking site; sending an e-mail; sending a SMS or other text message; advertising in print media, on billboards, over television, on radio or over the internet; calling on the telephone; or meeting in person.

The group 120 may be defined by any parameter that the provider 130 desires. By way of a non-limiting example, the group 120 may be defined by subscribers 110 who are interested in a common technology field or who produce products or hold patents or describe their businesses in terms of the common technology field, including a technology field that may be of interest to other potential or actual subscribers 110. A common technology field may for example, be broad such as biology, chemistry or physics, or it may be narrower, such as genetics, microbiology, bioinformatics, molecular biology, physical chemistry, organic chemistry, biochemistry, cellular phone technology, lasers, optics, electricity, magnetism, financial services, information or processing technologies, etc. Another basis for defining interest of subscribers 110 is on a product or field of commercial value, such as the primary commercial component of a product currently being sold or intended to be sold in the future. The group 120 may alternatively or additionally be limited by the owners of the patents, e.g., non-practicing entities individually or as a group in a particular field.

Upon joining the group 120, the potential subscribers 150 become registered subscribers 110. As noted above, the process for joining may include one or more of the following operations: submitting a request to join, providing a user name, providing a user password, selecting a group to join and providing funds. A subscriber 110 may elect to be a member of more than one group (not shown), and the provider 130 may require additional funds for the right to become a subscriber of more than one group.

The subscribers 110 may join because of the subscribers' interest in obtaining information relating to a topic. In some embodiments, the subscribers 110 would like to gain access to references that qualify as prior art with respect to one or more claims of one or more patents. In some embodiments, the prior art that is requested is limited to printed publications. Additionally, subscribers 110 may be interested not only in prior art that invalidates one or more patent claims, but also in references that provide evidence of the state of the art at a relevant time period, such as when a patent application was filed.

In operation 210, the provider 130 publicizes a first request for prior art. In some embodiments, this first request may be published after there is at least one or at least a plurality of (e.g., at least two, at least five, at least ten, at least fifteen) registered subscribers 110. In other embodiments, the first request is published prior to there being any registered subscribers 110, and the publication of it may serve as an inducement for the first subscribers 110 to join. The request may ask for prior art that is related to at least one patent claim of a first patent. In some embodiments the first request asks for prior art related to a plurality of claims of a patent either to invalidate the claim or as evidence of the state of the art. In some embodiments, the first request asks for prior art related to a plurality of patents. In some embodiments, the first request asks for prior art related to all claims of one or more patents.

The publication of the first request may for example, be through one or more of the following: over a network 140, through direct mailings such as direct e-mail, text messaging or traditional postal mailings, or through print media such as newspapers or billboards.

Following the publication of the first request for prior art, the provider 130 may receive a request, in operation 220 from at least one additional entity to join the group 120. The provider 130 may then permit the additional entity to become a registered subscriber 110. Through the publication of the first request, members of the public will become aware of the search. An entity that is a member of the public (including live persons and any other legal entity) who determines that the results of the search would be of interest to him or to her may contact the provider 130 and apply to become a member of the group 120 and thus entitled to the results of the first search and the results of any other searches. Although administratively, the provider 130 could create a class of per study recipients who pay only to have access to the results of one or more particular studies based on the patent at issue, the economics of scale are most noticeable when subscribers 110 pay for memberships to the group 120 and to all studies of interest to the group 120.

In operation 230, in response to the first request, the provider may receive prior art related to a claim or claims of the first patent. The provider may then provide access, in operation 240, to the results of the request for prior art related to the claim or claims of the first patent to the registered subscribers. Results may for example, be distributed as an attachment to an e-mail. The registered subscribers would include any additional entities who have become registered subscribers by the time of distribution of the results. All of the registered subscribers may be sent the results at the same or approximately the same time, or they may receive the results staggered, e.g., based on the order in which they joined the group or the relative fees paid by the subscriber.

In operation 250, the provider 130 may also publicize a second request for prior art. The second request may for example, ask for prior art that is related to at least one patent claim of a second patent or a state of the art of a technology of the second patent. In some embodiments, the second request is initiated by a request from a subscriber 110 or by a belief of the provider 130 that the results would be of interest to one or more of the subscribers 110 of the group 120. In some embodiments, the second request is publicized after an automatic triggering event. Examples of the triggering event include but are not limited to, an event selected from the group consisting of the filing of a complaint in court, wherein the second patent is the subject of litigation and the second patent is part of the common technology field; the notification that a non-practicing entity has acquired the second patent; notification that a member of the group has received contact from an owner of the second patent, wherein within the contact reference has been made to the second patent; receipt of a request from a subscriber to launch a study; and a profile of a patent in a news publication. The second request for prior art may be issued prior to the distribution of the results for the first request for prior art or after the distribution of the results.

By way of a non-limiting example of how to implement a method in which a second request is issued after a triggering event, the provider 130 may either continuously, continually, at regular intervals or at irregular intervals run a computer program product that mines one or more databases for recently filed patent litigations. Examples known services that collect data relevant to court filings are Prior Smart and PACER. The computer program product in example embodiments may obtain and cause the pleadings (e.g., complaints and/or answers) in those actions to be scanned, either by sending them to a person or through optical character recognition technology, and extract patent numbers of the patents that are the subject of those patents. The computer program product may then determine the subject matter of those patents by for example, executing an algorithm that reviews the words in the patent or a subset of the patent such as the claims, title and/or abstract. Alternatively or additionally, the computer program product may consider the classification (e.g., US or International) by the Patent Office that issued the patent and/or title, claims or abstract or any combination thereof to determine the field. A list of potential patents also can be passed to subscribers 110 to select.

With this information, the provider 130 can determine whether the results would be of interest to one or more of the subscribers 110 of one or more of the groups 120 for which it launches studies. This decision may, for example, be made by polling one or more subscribers 110 of the group 120 or the decision may be automated and turn on decision tree rules such as whether the patent at issue is within the scope of the common technology that defines the group 120. For example, if the group 120 is pharmaceuticals, the decision tree may compare the US classification on the face of the patent to a list of classification numbers that apply to pharmaceutical inventions, and if the classification is within the list, then launch the study without polling subscribers 110 of the group 120.

The provider 130 may then receive, in operation 260, prior art related to one or more claims of the second patent or to the state of the art of the technology of the second patent. Finally, the provider 130 may provide, in operation 270, access to the results of the request for prior art related to one or more claims of the second patent to the registered subscribers 110.

Subscription plans may be based on a temporal factor or number of studies or a combination thereof. For example, a subscriber 110 may subscribe for one year, two years, three years, four years, etc., or expiration may occur on the same date for all subscribers 110. In this latter case, early joiners will be subscribers 110 of the group 120 for a longer period of time, but all subscribers 110 could be given the option to extend membership beginning on the same date. Alternatively, a subscriber 110 may pay for access to results of a fixed number of studies, e.g., five, ten, fifteen, twenty, twenty-five or thirty. This may result in different subscribers 110 terminating their subscriptions at different times.

In some embodiments, one or more, if not all registered subscribers 110 within a group 120 may be notified that an additional entity 150 wishes to join the group 120 and of the identity of the additional entity. In some embodiments, at least one registered subscriber 110 may have the ability to deny subscriptions to the additional entity. Thus, the first registered subscriber 110 or one or more registered subscribers 110 may pay a fee for the right to determine whether additional members may be admitted, or each of the first one, two, three, four, five, six, seven, eight, nine, ten, eleven, twelve or more subscribers 110 may have this power to deny admissions. When more than one subscriber 110 has this power, the group 120 that has this power to deny admissions may be referred to as an admissions committee (not shown). The admissions committee may be set up so that each individual subscriber 110 has the ability to deny admissions to a new member 150 or a majority of the subscribers 110 must vote to admit a potential new member 150 before admission is granted or a supermajority e.g., at least two-thirds of the subscribers 110 of the admissions committee must vote in favor of admission before admission is granted. Voting can also be structured such that failure to vote is inferred as a vote in favor of admission.

As an incentive to be the first member to join, the provider 130 can establish an economic system in which the first potential subscriber who becomes a registered subscriber 110 receives a portion of any fees for subscriptions that are paid by other subscribers 110 of the group 120. The provider 130 could also establish an economic system wherein additional early subscribers 110, for example the second through fourth or second through fifth or second through sixth, or second through tenth, or second through twentieth, etc. receive portion of the fees from subsequent subscribers 110. Each earlier subscriber 110 may receive the same percentage of the admission fee of later subscribers 110 or the payments may be weighted depending on how early each member of the first tier joined, or a combination of these payment methodologies may be employed.

By way of a non-limiting example, the first registered subscriber 110 may receive five percent of the admissions fee for all subsequent subscribers 110. Alternatively, each of the first ten subscribers 110 may, for example, receive one-half of a percent of the admissions fees of all subsequent subscribers 110. In still another alternative embodiment, the first registered subscriber 110 may receive two percent of the admission fee of all subsequent subscribers 110 and each of the second through twentieth subscribers 110 would receive one-half of a percent of each subsequent subscriber's 110 fee. In still another embodiment, the first, second, third, fourth and fifth subscribers 110 would receive five percent, four percent, three percent, two percent and one percent, respectively of each registered subscriber's 110 fee beginning with the sixth registered subscriber 110. The aforementioned percentages are merely examples and similar models could be used with different numbers.

Membership in a group 120 may be self-selecting and open to the public, i.e., anyone who professes an interest and pays the requisite fee can join. Alternatively, the provider 130 may choose to design the pool of potential subscribers to include a plurality of defendants in one or more litigations, or to be limited to these parties. In these cases, the first patent may be the subject of the litigation. If there is more than one patent that is the subject of litigation, then one or more of those patents may be the subject of prior art studies. The plurality of prior art studies may be launched at the same time or sequentially.

The provider may 130 also design a pool of potential subscribers to comprise or to consist of entities who are interested in at least one technology area. In order to determine what entities may be interested in a technology area, the provider 130 may consider one or more of public literature sources about the entities, products sold by the entities, services provided by the entities, patent applications filed by the entities and patents issued to, licensed to or acquired by the entities.

The requests for prior art that are made to the public may ask that persons submit prior art according to methods that are now known or that come to be known for transmitting information, including but not limited to email and uploading to a server. In order to incentivize persons to submit information, a reward may be offered to the person or persons who first provide the most relevant information on a technical mapping basis, (i.e., prior art that alone or in combination with other references has a technical mapping to the technology description in the patent) or that meets the legal definition of a reference that qualifies as prior art under 35 U.S.C. §102 or 35 U.S.C. §103 (or comparable provision of the patent laws of other jurisdiction) as determined by an attorney (or other appropriately licensed person). If the reward is made available to a sufficiently large group of people, the benefit of crowdsourcing can be realized.

Through the use of the systems, methods and computer program products of various embodiments, one may enable a plurality of entities to share information cost-effectively and efficiently.

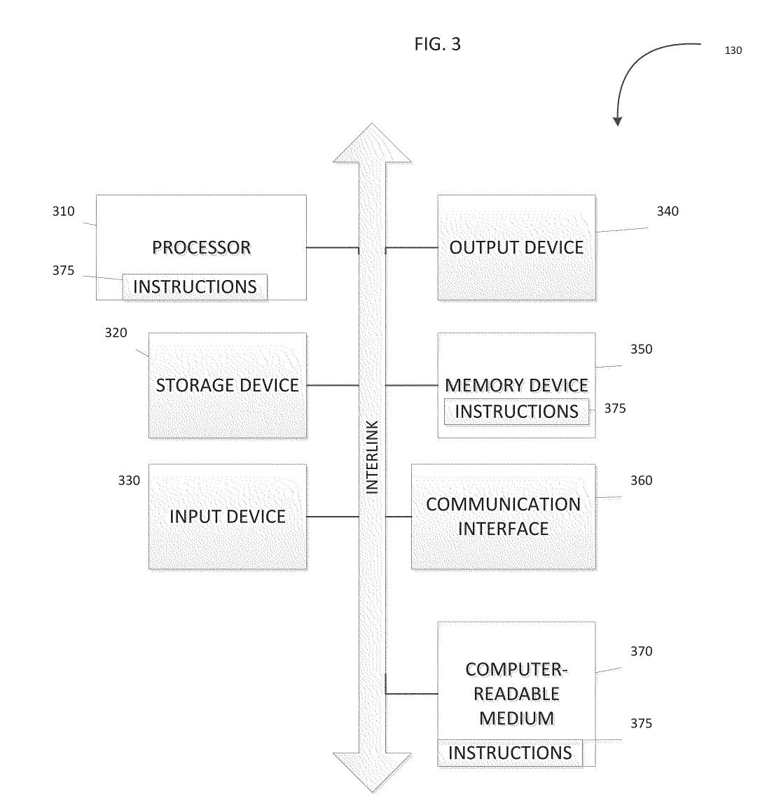

As shown in FIG. 3, the systems, methods and computer program products may be implemented through one or more computers or central processing units and may in part or whole be automated. For example, the systems, methods and computer program products may be implemented through one or more computers or servers of the provider 130. The phrase “central processing unit” and the abbreviation “CPU” are used interchangeably and refer to an electronic circuit that can execute a computer program and can accomplish electronic communication through for example a processor 310. A processor is the part of a computer that can execute instructions and manipulate data. The phrase “computer program product” as used herein, refers to instructions that can be stored on hardware, software or a combination of both.

The provider system 130 may have specific software, including a browser that standardizes communication with network servers. These servers may be any devices that are capable of receiving, delivering and sending email messages, text messages and/or other messages that are sent to it. Thus, a server may comprise a storage device 320, an input device 330, an output device 340, a memory device 350, a processor 310 and a communication interface 360.

The subscribers 110 and persons who submit prior art may communicate with the provider 130 through one or more input devices 330, output devices, and communication interfaces 360. An input device is any device that may be used to input, to select and/or to manipulate information. By way of example, input devices include, but are not limited to, a keyboard, a mouse, a graphic tablet, a joystick, a light pen, a microphone, and a scanner.

An output device may be any device that enables a computer to present information to a user, and includes, but is not limited to, a video display, a printer, and an audio speaker.

A communication interface 360 is a tool for receiving input and sending output. Thus, it is or is part of a portal or is operably coupled to a portal. By way of example, communication interfaces may include but are not limited to a modem, network interface card and requisite software such as for protocol conversion and data conversion to communicate through e.g., a LAN, WAN or otherwise over the Internet. A “portal” is a method, system or apparatus for connecting to a network. For example, a portal may be a means of accessing the Internet. Subscribers 110 and persons who submit prior art may communicate with the provider 130 through these technologies.

The prior art requests, the group memberships and the received prior art may be stored on one or more memory devices 350. A memory device 350 is a device that can store, retrieve or facilitate the retrieval of data. By way of example, a memory device may comprises one or more of Random Access Memory (RAM), Read Only Memory (ROM), a magnetic drive, a Digital Video Disk (DVD) drive, or removable media storage. This information may, for example, be stored in a database.

Other example embodiments provide a computer program product stored in a tangible medium 370. The medium may be a non-transitory tangible computer readable storage medium comprising a set of executable instructions that are capable of directing a computer to execute the necessary steps for the modules below to perform their intended purpose or to effectuate any of the methods described herein.

A “non-transitory tangible computer readable storage medium” may also be referred to as a computer program product, and includes hardware, software or a combination of the two on which one may store a set of instructions that may be used to direct a computer to perform a set of steps. Examples of non-transitory tangible computer readable storage medium include, but are not limited to, a hard drive, a hard disk, a floppy disk, a thumb drive, a computer tape, ROM, EEPROM, nonvolatile RAM, CD-ROM and a punch card. Thus, in some embodiments the instructions 375 are software stored on a medium that can instruct a computer having one or more of the following hardware components: memory, storage, an input device, an output device and a central processing unit. In some embodiments, the instructions 375 are stored on the processor 310 or the memory device 350 such that the processor 310 and the memory device 350 act as computer-readable mediums.

The systems and computer program products may, for example, be organized in modules (not shown). The term “module” refers to a computer program product that may be stored on hardware and/or software that may be activated by a user to carry out a defined set of steps and/or to prompt a user to provide information through, for example, a graphic user interface and/or input/output device. Thus, a module may be stored in the form of a tangible medium. Modules that may be of use in implementing the methods in accordance with example embodiments include but are not limited to: (1) a subscription offering module; (2) a membership module; (3) a prior art request module; (4) a trigger module; (5) a receipt of prior art module; (6) a prior art database module; and (7) a results transmission module. Each module may be operably coupled to other modules in order to permit that module to carry out its intended purpose.

The subscription offering module comprises a set of instructions that when executed offers potential subscribers one or more options for joining a group 120. The offer may, for example, be a subscription plan that entitles one to membership in a particular group 120. This module may permit a user to submit user identification information and a fee to become a member of the group 120. Upon receipt of this information and fee, the subscription module may provide or ask the user to create a user password.

The membership module is operably coupled to the subscription module. After the subscription module has been activated and a new member has applied for membership to the group 120, the membership module may access a database, on for example memory device 350 that contains the identity of all members of a group 120, and add the new member to that group. This membership database may be configured so as to include all members of all groups (not shown) and have a field that specifies the group or groups to which a member belongs.

In some embodiments, the membership module contains an algorithm that, after receiving an application for membership from the subscription module, causes a request to be sent to existing members that asks existing members whether they want to permit the new applicant to join. The algorithm may allow existing subscribers 110 a certain amount of time to object to the new members (e.g., 2 days or a week), and then after collecting any objections, compare the number of objections to any rule that has been put in place for the group 120 in order to determine whether membership should be allowed. For example, if the rule is that if three existing subscribers 110 object to a new member, membership is denied, and four existing subscribers 110 do object, the applicant will be notified and membership will be denied. If, however, these rules are in place and only two existing subscribers 110 object, membership will be allowed.

The prior art request module is a module that broadcasts requests for prior art. The prior art request module may be configured to broadcast these requests over public channels including, but not limited to posting on a website over the internet. As used herein the “prior-art request” module can be used to request references that invalidate one or more claims of a patent or provide information as to the state of the art of a technology.

The trigger module is operably coupled to the prior art request module. The trigger module can send instructions to the prior art request module to launch a request. The trigger module may be activated by receiving instructions from a user or the provider to launch a specific request or by an automatic event. The automatic event may, for example, be the receipt of notification that a patent has been acquired by a specific entity or a patent is the subject of litigation.

The receipt of prior art module is configured to receive and to store results received from a prior art request issued by the prior art request module. The prior art request module and the receipt of prior art modules are operably coupled so as to permit the system to relate prior art received to requests made. Preferably, the receipt of prior art module is configured to receive art from remote submitters over a network such as, the internet.

The prior art database module is operably coupled to the receipt of prior art module. The prior art database module permits one or more of the storage of prior art, the linking of prior art to specific prior art requests, the identification of the submitter of the art, notes related to the art and a ranking of the quality of the art.

The results transmission module is operably linked to the membership module, and the prior art database module. The results transmission module is capable of one or more of the following: generating a list of all prior art received for a study and sending the list to all subscribers 110 of a group 120 who are entitled to the results; sending all of the art to the subscribers 110 of the group 120; receiving a summary of one or more of the references and sending the summary to the appropriate subscribers 110; and sending a subset of results, e.g., the best results. Determination of the best results may for example, be made after reviewers have assigned numerical values to the significance of a result and the ranking the results based on those values.

Example embodiments may be used in connection with of crowdsourcing. Each of these improvements may be used with the aforementioned methods, systems and computer program products or alone or with other methods, systems and computer program products that are now known or that come to be known and that may be recognized as being of use with them.

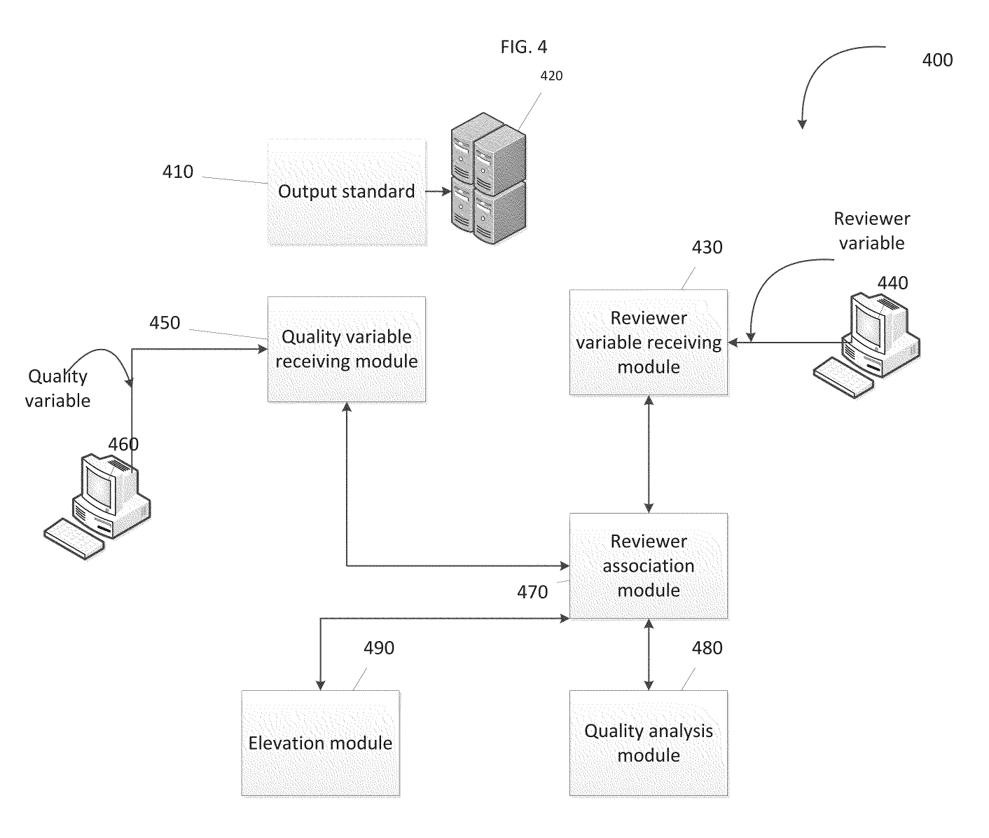

FIG. 4 is a system 400 for analyzing the validity of one or more patent claims, the claims of infringement, the evidence of use, the state of the art or whether there is freedom to operate with respect to an article, composition, method or process as compared to one or more claims of a patent, according to at least one example embodiment.

The system 400 may comprise an output standard 410. The output standard 410 may be stored in computer readable form on, for example, a server 420, and the output standard 410 refers to criterion or criteria against which the submission, e.g., prior art is measured and may, for example, be a likelihood that a particular patent will withstand a validity challenge based on a prior art reference alone or in combination with other references. Thus, it is the criteria against which the value of the prior art is measured.

The system 400 may also contain a reviewer variable receiving module 430. The reviewer variable receiving module 430 is configured to receive a plurality of reviewer variable values from a plurality of reviewers 440. Thus, after a reviewer 440 examines a reference, she may submit, and the system 400 may receive, a variable indicating the value of the reference with respect to the validity of a claim.

The system 400 may also contain a quality variable receiving module 450. The quality variable receiving module 450 is configured to receive from a quality review committee member 460 a quality variable value to associate with a reviewer variable value. This quality review committee member 460 reviews that conclusion of the reviewer 440. The quality variable value provides information as to the quality of the reviewer's 440 evaluation of the significance of the art.

The system 400 may also comprise a reviewer association module 470 that is operably coupled to the reviewer variable receiving module 420 and to the quality variable receiving module 450. This enables the system 400 to receive and to associate with each reviewer variable value, at least one quality variable value. The values may be stored in computer readable form.

The system 400 may also comprise a quality analysis module 480 that is operably coupled to the reviewer association module 470. For each patent document for which a quality variable value has been received, an automated analysis may be performed to determine whether the reviewer variable value satisfies a quality condition.

The system may also comprise an elevation module 490. The elevation module 490 extracts data from the reviewer association module 470, and it determines when a reviewer 440 may submit a quality variable value as a committee member. The system 400 may operate under a set of rules such that when a reviewer 440 has reviewed a predetermined number of patent documents and has received a predetermined number of high quality variable values (and/or a certain percentage of high marks), he or she may become a quality review committee member. In some embodiments, for a given study, a person may serve as either a reviewer 440 or committee member 460 but not both. In other studies, a person may act in both capacities, but not submit a review variable and a quality variable for the same reference.

The system 400 may also comprise an output module (not shown). The output module may generate a report that identifies a subset of patent documents that satisfy the quality condition and the output standard. Thus, it may look for references that both satisfy the output standard (e.g., have been rated as being highly relevant or have a rating variable assigned to it of a sufficiently high value) and for whom the reviewer's 440 determination has been determined to be of sufficient quality. In some embodiments, the system 400 receives at least one quality variable value for a first patent document and at least one reviewer variable value for a second patent document from a committee member 460 who is also a reviewer 440.

In some embodiments, a set of patent documents comprises at least one of issued patents, published patent applications or combinations thereof.

In some embodiments, the number of patent documents may for example be at least fifty, at least 100, at least 200, at least 300, at least 500, etc.

In some embodiments, numbers of reviewers may, for example, be at least twenty, at least thirty, at least forty, at least fifty, etc., at least one-hundred etc.

The system 400 may further comprise an input blockade (not shown). An input blockade may be a computer algorithm that precludes a reviewer 440 from submitting a reviewer variable value for the same patent document for which the reviewer 440 has submitted a quality variable value. When a person attempts to do this, the system 400 may notify the person and/or the host that this condition has occurred and refuse to accept either or both inputs.

The system 400 may also comprise an input blockade (not shown) that precludes a committee member 460 from submitting a quality control variable value for the same patent document for which the committee member 460 submitted a reviewer variable value.

The system 400 may also comprise a patent document assignment module (not shown). The patent document assignment module may randomly assign one or more patent documents to each reviewer 440.

In some embodiments, the reviewer variable receiving module 430 receives at least two reviewer variable values from at least two reviewers 440 for said first patent document.

In some embodiments, the quality value receiving module 450 receives at least two quality value variables from at least two committee members 460 for the first patent document. In some embodiments, the at least two quality value variables are combined to form a combined quality value, and the quality condition is measured against the combined quality value, which determines whether to accept a reviewer's 440 assigned value.

The system 440 may also comprise a review status module (not shown). The review status module stores information comprising whether a reviewer's 440 variable value has been received.

In some embodiments, the output module is activated after at least one reviewer variable value has been received for each patent document and the report is generated only if the quality condition has been met for at least one reviewer variable value for each patent document. When a plurality of reviewer variable values has been received for the same reference, they may be averaged. The system 400 may choose to include all variables values or only those determined to be of sufficient quality.

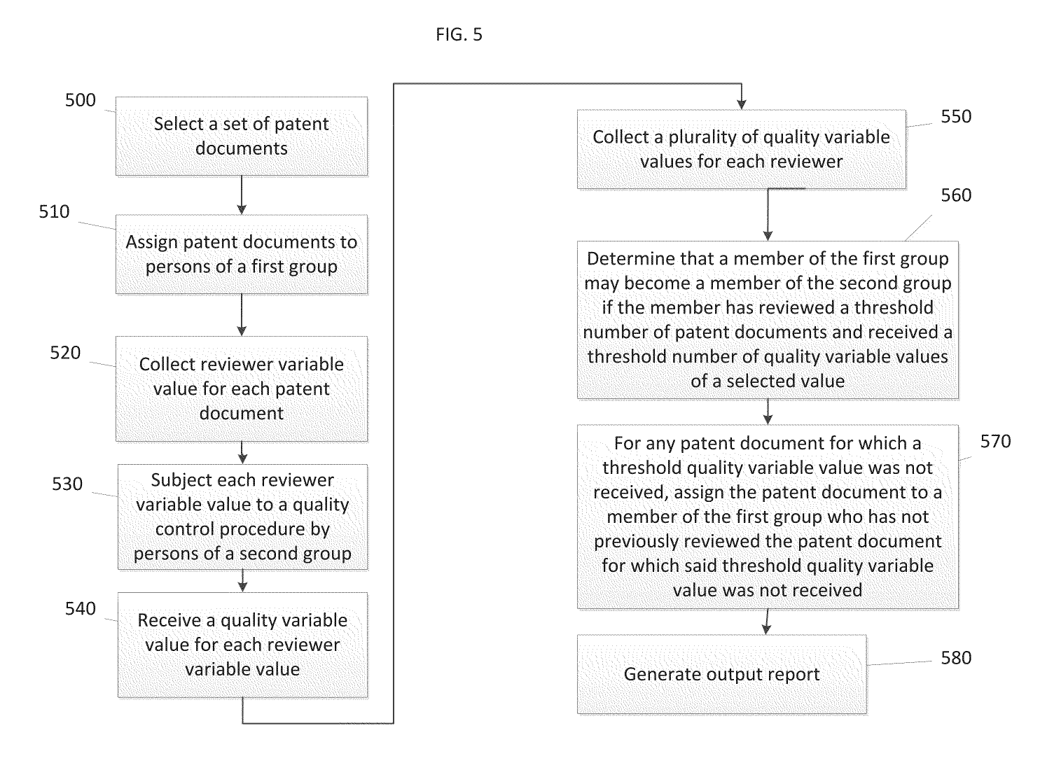

FIG. 5 depicts a method for reviewing a plurality of patent documents in accordance with example embodiments. The method may begin with operation 500, in which the system 400 selects a set of patent documents that comprises any one of at least two patent documents, at least five patent documents, at least ten patent documents, at least twenty patent documents, etc.

In operation 510, the method assigns two or more patent documents from the set of patent documents to two or more persons from a first group of persons. Next in operation 520 the system 400 collects a reviewer variable value for each patent document. Each reviewer variable value is received from a person who is a member of the first group of persons and the reviewer variable value defines the degree to which a user-defined condition has been satisfied. The user-defined condition may be, for example, the degree to which a patent claim may or may not withstand a validity challenge based on a reference, the degree to which a reference is enabling, the type of document, e.g., non-patent literature or written in a foreign language.

Next, in operation 530, the system 400 subjects each reviewer variable value to a quality control procedure performed by one or more persons from a second group of persons. The person from the second group submits a quality variable value for each reviewer variable value. The value may be received by a host system 400 in operation 540. Preferably, in operation 550, the system 400 collects a plurality of quality variable values for each reviewer. In operation 560, the system 400 determines that a member of the first group of persons may become a member of the second group of persons if the member of the first group of persons has reviewed a threshold number of patent documents and received a threshold number of quality variable values of a selected value or greater than a selected value. The system 400 may further receive a quality variable value from a member of the second group of persons for a first patent document, wherein the member of the second group of persons is also a member of the first group of persons and has submitted a reviewer variable value for a second patent document.

For any patent document for which a threshold quality variable value was not received, the system 400 assigns, in operation 570, the patent document to a member of the first group who has not previously reviewed the patent document for which said threshold quality variable value was not received. This improves the quality of results.

After all patent documents have been reviewed and there is a reviewer variable value associated with a quality variable value that is at least as high as the threshold quality variable value, the system 400, in operation 580, generates an output report, wherein the output report identifies a subset of patent documents that comply with the user-defined condition.

The methods of this embodiment are not limited to documents that invalidate the claims of a patent. For example, the information to be reviewed may be documents that are indicative of the state of the art of a particular technology. A first group of persons may submit variables that indicate the degree to which references accurately depict the state of the art, which corresponds to the reviewer variable value. A second group of persons will review the degree to which reviewer variable values of the first group are accurate and in turn submit their quality variable values.

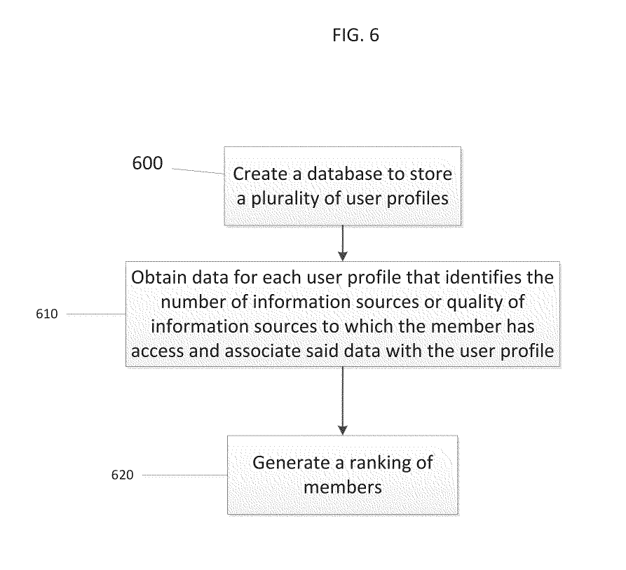

FIG. 6 illustrates a method for ranking members of a group in accordance with some embodiments. In operation 600, the system 400 creates a database that stores a plurality of user profiles. Each user profile corresponds to a member of a group. For each user profile, the system 400, in operation 610, obtains data that identifies the number of information sources and/or quality of information to which the member has access and associating the data with the user profile.

Finally, the system 400, in operation 620, generates a ranking of members. The ranking assigns a relative value to members based on the number and/or quality of information sources to which the member has access.

Information sources may, for example, comprise minutes from meetings of standards setting bodies. In some embodiments, the information sources comprise or consist of sources that are not accessible to the public.

In another embodiment, there is a method for ranking members of group. This method comprises creating a database that stores a plurality of user profiles. Each user profile corresponds to a member of a group. For each user profile, the method calls for obtaining a first piece of data that identifies the number of information sources to which the member has access and associating the first piece of data with the user profile. For each user profile, the method also calls for obtaining a second piece of data that identifies a member's prior participation in information searches and associating the second piece of data with the user profile. The method comprises, assigning a value to first variable wherein the value of the first variable reflects a relative ranking of the member compared to other members with respect to the access and/or quality of information sources.

Further, the method may comprise, assigning a value to second variable wherein the value of the second variable reflects a relative ranking of the member compared to other members with respect to the member's prior participation in information searches.

Finally, the method may comprise generating a ranking of members, wherein the ranking assigns a relative value to members based on the combined value of the first variable and the value of the second variable. These variables may be added or multiplied in order to provide a composite score.

Some example embodiments provide a method for quantifying the value of an on-line community. The method comprises creating a database that stores a plurality of user profiles, wherein each user profile corresponds to a member of a group. For each user profile, the method calls for obtaining data that identifies the information sources to which the member has access and associating the data with the user profile. The method may further comprise determining the number of non-duplicative information sources identified within the database for the group. The determining is e.g., performed by a central processing unit. Finally, the method may e.g., comprise outputting in a computer readable form a value that reflects the number of non-duplicative information sources.

In some embodiments, the method further comprises outputting at least one of the number of user profiles, the mean number of information sources, the medium number of information sources per member, the mode number of information sources per member, the standard deviation of information sources per user profile and the average member of unique sources per member.

Unless otherwise specified, any of the features of the various embodiments described herein can be used in conjunction with features described in connection with any other embodiments disclosed. Accordingly, features described in connection with the various or specific embodiments are not to be construed as being unsuitable in connection with other embodiments disclosed herein unless such exclusivity is explicitly stated or implicit from the context.

We claim:

1. A method for generating and sharing information among a plurality of registered subscribers, the method comprising:
offering a plurality of potential subscribers an opportunity to join a group, wherein the group is comprised of members who are interested in a common technology field and upon joining the group, the potential subscribers become registered subscribers;
publicizing a first request for prior art, wherein the first request asks for prior art that is related to at least one patent claim of a first patent or to a state of the art of a technology of said first patent;
receiving a request from at least one additional entity to join the group and permitting the additional entity to become a registered subscriber;
receiving prior art related to said claim of said first patent or to said state of the art of the technology of said first patent;
providing access to results of the request for prior art related to said claim of the first patent or said state of the art of the technology of said first patent to the registered subscribers;
publicizing a second request for prior art, wherein the second request asks for prior art that is related to at least one patent claim of a second patent or a state of the art of a technology of said second patent, wherein the second request is publicized after an automatic triggering event, wherein the triggering event is an event selected from the group consisting of
the filing of a complaint in court, wherein the second patent is the subject of litigation, and the second patent is part of said common technology field;
the notification that a non-practicing entity has acquired said second patent; and
notification that a member of the group has received contact from an owner of the second patent, wherein within said contact reference has been made to the second patent;
receiving prior art related to a claim of said second patent or to said state of the art of the technology of the second patent; and
providing access to the results of the request for prior art related to said claim of the second patent or the state of the art of the technology of the second patent to the registered subscribers.

2. The method according to claim 1, wherein each registered subscriber is notified that an additional entity wishes to join the group, and at least one registered entity has the ability to deny membership to the additional entity.

3. The method according to claim 1, wherein the first potential subscriber to become a registered subscriber receives a portion of any fees for subscription that are paid by other members of the group.

4. The method according to claim 1, wherein prior to joining the group, the additional entity must pay a fee and a portion of that fee is given to one or more entities that are registered subscribers.

5. The method according to claim 4, wherein the portion of the fee is paid only to the first ten or fewer registered subscribers.

6. The method according to claim 1, wherein a plurality of the potential subscribers are defendants in one or more litigations.

7. The method according to claim 6, wherein the first patent is the subject of the litigation.

8. The method according to claim 1, wherein each member of the group is notified of the identity of every other member of the group.

9. The method of claim 1, wherein the plurality of potential subscribers are selected from a pool of entities who are interested in at least one technology area.

10. The method of claim 1, wherein the first request is for prior art that invalidates said claim of the first patent.

11. A method for ranking members of a group, said method comprising:
creating a database that stores a plurality of user profiles, wherein each user profile corresponds to a member of a group;
for each user profile, obtaining data that identifies the number of information sources or quality of information sources to which the member has access and associating said data with the user profile; and
generating a ranking of members wherein said ranking assigns a relative value to members based on the number of information sources to which the member has access.

12. The method according to claim 11, wherein the information sources comprise minutes from meetings of standards setting bodies.

13. The method according to claim 11, wherein the information sources consist of minutes from meetings of standards setting bodies.

14. The method according to claim 11, wherein the information sources consist of sources that are not accessible to the public.

15. A method for reviewing a plurality of patent documents, said method comprising:
selecting a set of patent documents that comprises at least two patent documents;
assigning two or more patent documents from said set of patent documents to two or more persons from a first group of persons;
collecting a reviewer variable value for each patent document, wherein each of said reviewer variable value is received from a person who is a member of the first group of persons, and the reviewer variable value defines the degree to which a user-defined condition has been satisfied;
subjecting each reviewer variable value to a quality control procedure performed by one or more persons from a second group of persons;
receiving a quality variable value for each reviewer variable value, wherein said quality variable value is received from a person who is a member of the second group of persons;
collecting a plurality of quality variable values for each reviewer;
determining that a member of the first group of persons may become a member of the second group of persons if the member of the first group of persons has reviewed a threshold number of patent documents and received a threshold number of quality variable values of a selected value;
receiving a quality variable value from a member of the second group of persons for a first patent document, wherein the member of the second group of persons is also a member of the first group of persons and has submitted a reviewer variable value for a second patent document;
for any patent document for which a threshold quality variable value was not received, assigning the patent document to a member of the first group who has not previously reviewed the patent document for which said threshold quality variable value was not received; and
after all patent documents have been reviewed and there is a reviewer variable value associated with a quality variable value that is at least as high as the threshold quality variable value, generating an output report, wherein the output report identifies a subset of patent documents that comply with the user-defined condition.

16. The method according to claim 15, wherein the first group is comprised of at least fifty members.

17. The method according to claim 16, wherein each member of the first group submits reviewer variable values for at least ten patent documents.

18. The method according to claim 15, wherein the second group comprises at least ten members.

19. The method according to claim 18, wherein the set of patent documents comprises at least one-hundred patents

20. The method according to claim 19, wherein at least ten members of the first group are members of the second group.
